(19) United States
(12) Patent Application Publication
(10) Pub. No.: US 2025/0165805 A1
(43) Pub. Date: May 22, 2025

(54) META LEARNING METHOD OF DEEP LEARNING MODEL AND META LEARNING SYSTEM OF DEEP LEARNING MODEL

(71) Applicant: Alipay (Hangzhou) Information Technology Co., Ltd., Hangzhou (CN)

(72) Inventors: Youshao XIAO, Hangzhou (CN); Shangchun ZHAO, Hangzhou (CN); Zhenglei ZHOU, Hangzhou (CN); Zhaoxin HUAN, Hangzhou (CN); Lin JU, Hangzhou (CN); Xiaolu ZHANG, Hangzhou (CN); Lin WANG, Hangzhou (CN); Jun ZHOU, Hangzhou (CN)

(21) Appl. No.: 18/920,400

(22) Filed: Oct. 18, 2024

(30) Foreign Application Priority Data
Oct. 20, 2023 (CN) 202311367619.1

(51) Int. Cl. G06N 3/0985; G06N 3/084

(52) U.S. Cl. CPC G06N 3/0985; G06N 3/084

(57) ABSTRACT

This specification provides a meta learning method of a deep learning model and a meta learning system of a deep learning model, and relates to the field of deep learning technologies. The meta learning method of a deep learning model is applied to a cluster including N processing nodes, and the method includes: obtaining a training dataset, where the training dataset includes training samples corresponding to a plurality of tasks; and performing a plurality of times of iterative training on the deep learning model based on the training dataset in parallel by using the N processing nodes in the cluster, to obtain a meta learning parameter of the deep learning model, In each time of iterative training, each of the N processing nodes learns some parameters of the deep learning model by using some training samples in the training dataset, and the some training samples correspond to a same task.

### TECHNICAL FIELD

This specification relates to the field of deep learning technologies, and in particular, to a meta learning method of a deep learning model and a meta learning system of a deep learning model.

### BACKGROUND

A deep learning model can be widely applied to an intelligent delivery scenario, for example, an advertisement release scenario, an intelligent search scenario, and an intelligent recommendation scenario. For the intelligent delivery scenario, a cold start problem may exist. To be specific, because a customer conversion amount is relatively small, a technical indicator (for example, an area under the receiver operating characteristic (AUC)) is usually low. To resolve the cold start problem of the deep learning model, a cold start customer can quickly accumulate the conversion amount through meta learning. Usually, a model agnostic meta learning (MAML) algorithm is used to implement a meta learning process. Currently, another meta learning algorithm in the industry is derived based on the MAML algorithm, and only a neural network layer structure or an optimization method of an optimizer is changed. Because a quantity of model parameters of the deep learning model is large, in a related technology, if an existing MAML optimization algorithm is used to perform meta learning of the deep learning model, there is a problem of low efficiency.

Content of the background part is merely information learned of by the inventor, and neither means that the information has entered a public domain before an application date of this disclosure, nor means that the information can become a conventional technology of this disclosure.

### SUMMARY

A meta learning method of a deep learning model and a meta learning system of a deep learning model provided in this specification can improve meta learning efficiency.

According to a first aspect, this specification provides a meta learning method of a deep learning model, applied to a cluster including N processing nodes. N is an integer greater than 1, and the method includes: obtaining a training dataset, where the training dataset includes training samples corresponding to a plurality of tasks; and performing a plurality of times of iterative training on the deep learning model based on the training dataset in parallel by using the N processing nodes, to obtain a parameter of the deep learning model, where in each time of iterative training, each of the N processing nodes learns some parameters of the deep learning model by using some training samples in the training dataset, and the some training samples correspond to a same task in the plurality of tasks.

In some embodiments, the parameter of the deep learning model includes an embedding layer parameter and a dense layer parameter; and each processing node learns some parameters in the embedding layer parameter and all parameters in the dense layer parameter by using the some training samples.

In some embodiments, the training dataset includes a plurality of data batches, and a process of each time of iterative training includes: performing the following operations by using the i^{th} processing node:
determining a target data batch, and dividing the target data batch into a support set and a query set, where the target data batch includes the some training samples, and the target data batch is one of the plurality of data batches; performing an inner loop training process, where the inner loop training process includes: determining a first embedding layer parameter, determining an inner-loop loss function based on the support set, the first embedding layer parameter, and a current dense layer parameter, and updating the first embedding layer parameter and the current dense layer parameter by optimizing the inner-loop loss function, where the current dense layer parameter is updated to an intermediate dense layer parameter; and performing an outer loop training process, where the outer loop training process includes: determining a second embedding layer parameter, determining an outer-loop loss function based on the query set, the second embedding layer parameter, and the intermediate dense layer parameter, and updating the second embedding layer parameter and the intermediate dense layer parameter by optimizing the outer-loop loss function. A value of i is a positive integer less than or equal to N, and the first embedding layer parameter and the second embedding layer parameter each correspond to at least some parameters in the embedding layer parameter.

In some embodiments, before performing an inner loop training process, the method further includes: interacting with another processing node in the cluster, to obtain a current embedding layer parameter corresponding to the support set, and obtain a current embedding layer parameter corresponding to the query set; determining a first embedding layer parameter includes: determining that the current embedding layer parameter corresponding to the support set is the first embedding layer parameter, where the first embedding layer parameter is updated to a third embedding layer parameter after the inner loop training process; and determining a second embedding layer parameter includes: determining the second embedding layer parameter based on the current embedding layer parameter corresponding to the query set or the third embedding layer parameter.

In some embodiments, the determining the second embedding layer parameter based on the current embedding layer parameter corresponding to the query set or the third embedding layer parameter includes: when the query set and the support set have an overlapping element, for an embedding layer parameter corresponding to the overlapping element in a training sample of the query set, determining that the third embedding layer parameter is the second embedding layer parameter; and for an embedding layer parameter corresponding to an element other than the overlapping element in the training sample of the query set, determining that the current embedding layer parameter corresponding to the query set is the second embedding layer parameter; or when the query set and the support set have no overlapping element, determining that the current embedding layer parameter corresponding to the query set is the second embedding layer parameter.

In some embodiments, the determining an inner-loop loss function based on the support set, the first embedding layer parameter, and a current dense layer parameter includes: performing forward computation based on the support set, the first embedding layer parameter, and the current dense layer parameter, to determine the inner-loop loss function; and updating the first embedding layer parameter and the current dense layer parameter by optimizing the inner-loop loss function includes: performing local gradient backward propagation on the inner-loop loss function, to update the first embedding layer parameter and the current dense layer parameter.

In some embodiments, updating the second embedding layer parameter by optimizing the outer-loop loss function includes: computing a gradient of the outer-loop loss function with respect to the embedding layer parameter, to obtain a sub-embedding layer gradient corresponding to the i^{th} processing node; interacting with another processing node in the cluster, to obtain a sub-embedding layer gradient corresponding to the another processing node in the cluster; performing aggregation computation on sub-embedding layer gradients corresponding to the N processing nodes, to obtain a target embedding layer gradient; and updating the second embedding layer parameter based on the target embedding layer gradient.

In some embodiments, the processing node is a graphics processing unit (GPU) node; and interacting with another processing node in the cluster, to obtain a sub-embedding layer gradient corresponding to the another processing node in the cluster includes: interacting with the another processing node in the cluster by using a first collective communication primitive AlltoAll, to obtain the sub-embedding layer gradient corresponding to the another processing node in the cluster.

In some embodiments, updating the intermediate dense layer parameter by optimizing the outer-loop loss function includes: determining a gradient of the outer-loop loss function with respect to the dense layer parameter, to obtain a sub-dense layer gradient corresponding to the i^{th} processing node; interacting with another processing node in the cluster, to obtain a sub-dense layer gradient corresponding to the another processing node in the cluster; performing aggregation computation on sub-dense layer gradients corresponding to the N processing nodes, to obtain a target dense layer gradient; and updating the intermediate dense layer parameter based on the target dense layer gradient.

In some embodiments, the processing node is a graphics processing unit (GPU) node; and interacting with another processing node in the cluster, to obtain a sub-dense layer gradient corresponding to the another processing node in the cluster includes: interacting with the another processing node in the cluster by using a second collective communication primitive AllReduce, to obtain the sub-dense layer gradient corresponding to the another processing node in the cluster.

In some embodiments, before the performing a plurality of times of iterative training on the deep learning model based on the training dataset in parallel by using the N processing nodes, the method further includes: dividing the embedding layer parameter, to obtain N subsets; and storing a parameter in the i^{th} subset and the dense layer parameter in the i^{th} processing node, where a value of i is a positive integer less than or equal to N.

In some embodiments, the training dataset includes a plurality of data batches, and obtaining a training dataset includes:
determining training samples respectively corresponding to P tasks, where each training sample includes a task identifier of a task to which the training sample belongs, and P is an integer greater than 1; and splitting the training samples respectively corresponding to the P tasks into Q data batches based on a predetermined batch size, to obtain the training dataset, where task identifiers of training samples belonging to a same data batch are consistent, and Q is an integer greater than P.

In some embodiments, the processing node is a graphics processing unit (GPU) node, the N processing nodes are deployed on a plurality of physical devices, and in a process of the plurality of times of iterative training, different processing nodes within a same physical device communicate through a high-speed connection channel NVLink, and different physical devices communicate through remote direct memory access (RDMA).

In some embodiments, the deep learning model is a deep learning recommendation model (DLRM).

According to a second aspect, this specification provides a meta learning system of a deep learning model, including N processing nodes. N is an integer greater than 1. Each processing node includes: at least one storage medium, storing at least one instruction set, and configured to perform meta learning of the deep learning model; and at least one processor, communicatively connected to the at least one storage medium. When the meta learning system of a deep learning model runs, the at least one processor in each processing node reads and executes the at least one instruction set, to implement the meta learning method of a deep learning model according to any embodiment of the first aspect.

It can be learned from the above-mentioned technical solutions that the meta learning method of a deep learning model provided in this specification is applied to the cluster including the N processing nodes. Specifically, the training dataset including the training samples respectively corresponding to the plurality of tasks is first obtained. Further, the plurality of times of iterative training are performed on the deep learning model based on the training dataset in parallel by using the N processing nodes in the cluster, to obtain a meta learning parameter of the deep learning model. In each time of iterative training, the parameter of the deep learning model is distributed on each processing node in the cluster, and each processing node learns some parameters of the deep learning model by using some training samples in the training dataset. It can be learned that, each processing node executes a training task by using the some training samples, to implement parallel training of training data. In addition, each processing node is responsible for learning some parameters of the model, to implement parallel training of the model. Therefore, the embodiments of this specification provide a hybrid parallel meta learning manner, to reduce graphics memory redundancy and help improve meta learning efficiency of the deep learning model.

Other functions of the meta learning method of a deep learning model and the meta learning system of a deep learning model provided in this specification are partially listed in the following descriptions. Based on the descriptions, content described by using the following numbers and examples is clear to a person of ordinary skill in the art. Creative aspects of the meta learning method of a deep learning model and the meta learning system of a deep learning model provided in this specification can be fully explained by practice or by using the methods, apparatuses, and combinations described in the following detailed examples.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic structural diagram of a meta learning system of a deep learning model according to an embodiment of this specification;

FIG. 2 is a schematic structural diagram of a computing device according to some embodiments of this specification;

FIG. 3 is a schematic flowchart of a meta learning method of a deep learning model according to an embodiment of this specification;

FIG. 4 is a schematic structural diagram of a deep learning recommendation model according to an embodiment of this specification;

FIG. 5 is a schematic flowchart of data preprocessing according to an embodiment of this specification;

FIG. 6 is a schematic diagram of loading a sample in a training stage according to an embodiment of this specification;

FIG. 7 is a schematic diagram of a meta learning framework of a deep learning model according to an embodiment of this specification; and

FIG. 8 is a schematic flowchart of a meta learning method of a deep learning model according to an embodiment of this specification.

### DESCRIPTION OF EMBODIMENTS

Specific application scenarios and requirements of this specification are provided in the following descriptions, so that a person skilled in the art can manufacture and use content of this specification. For the person skilled in the art, various local modifications to the disclosed embodiments are clear, and the general principles defined herein can be applied to other embodiments and applications without departing from the spirit and scope of this specification. Therefore, this specification is not limited to the shown embodiments, but has a widest scope consistent with that of the claims.

The terms used herein are only intended to describe a particular example embodiment, but do not impose a limitation. For example, unless otherwise specified in the context, the singular forms “one”, “a”, and “the” used herein can also include a plural form. When used in this specification, the terms “include”, “include”, and/or “have” indicate/indicates existence of an associated feature, integer, step, operation, element, and/or component, but does not exclude existence of one or more other features, integers, steps, operations, elements, components, and/or groups, or another feature, integer, step, operation, element, component, and/or group can be added to the system/method.

In consideration of the following descriptions, these and other features of this specification, operations and functions of related components of the structure, and economy of combination and manufacturing of components can be significantly improved. With reference to the accompanying drawings, all of these form a part of this specification. However, it should be clearly understood that the accompanying drawings are merely used for the purpose of illustration and description, and are not intended to limit the scope of this specification. It should be further understood that the accompanying drawings are not drawn to scale.

The flowchart used in this specification illustrates operations implemented by a system in some embodiments of this specification. It should be clearly understood that operations in the flowchart can be implemented out of sequence. On the contrary, operations can be implemented reversely or simultaneously. In addition, one or more other operations can be added to the flowchart. One or more operations can be removed from the flowchart.

In this specification, “X includes at least one of A, B, or C” means that X includes at least A, or X includes at least B, or X includes at least C. In other words, X can include only any one of A, B, and C, or simultaneously include any combination of A, B, and C and other possible content/elements. Any combination of A, B, and C can be A, B, C, AB, AC, BC, or ABC.

In this specification, unless expressly stated, an association relationship generated between structures can be a direct association relationship or an indirect association relationship. For example, when “A and B are connected” is described, it should be understood that A can be directly connected to B or can be indirectly connected to B, unless it is explicitly stated that A and B are directly connected. For another example, when “A is above B” is described, it should be understood that A can be directly above B (A is adjacent to B and A is above B) or A can be indirectly above B (A and B are separated by another element and A is above B), unless it is explicitly stated that A is directly above B; and so on.

First, noun terms related to one or more embodiments of this specification are explained.

Meta learning: Meta learning in deep learning is a technology that enables a machine to learn how to quickly adapt to a new task. Usually, in deep learning, a large amount of labeled data and a large amount of training time need to be used to learn to resolve a specific task. However, in real life, however, the machine needs to be able to quickly adapt and learn when facing a new task, rather than being trained again from scratch. Meta learning aims to enable the machine to learn how to quickly learn when facing a new task. In meta learning, the machine is trained to learn from a series of different tasks, and generality and a pattern are extracted from the series of different tasks. In this way, the machine can learn of a capability of “learning how to learn”, so that when facing the new task, the machine can adapt and resolve a problem more quickly based on previously learned knowledge and experience.

Deep learning model: For a deep learning model in an advertisement search recommendation (ASR) scenario, performance is that an embedding layer (word table) is very huge in an engineering technology, and is usually tens of GB or hundreds of GB. Because only a small quantity of embedding vectors in the word table are used for model updating in an iteration, the deep learning model is also referred to as a sparse model.

A deep learning recommendation model (DLRM) is mainly a deep learning model in an ASR scenario.

AlltoAll: All-To-All is a collective communication primitive, data of operating each node by using AlltoAll are distributed on all nodes in a cluster, and each node collects data of all nodes in the cluster. AlltoAll is an extension to ALLGATHER. A difference is that in the ALLGATHER operation, data collected by different nodes from a node are the same; and in ALLTOALL, data collected by different nodes from a node are different.

AllReduce: AllReduce is another collective communication operation, and is used to perform data aggregation between a plurality of processes. In the AllReduce operation, each process aggregates local data of the process with local data of another process, and finally obtains a global aggregation result.

An MAML optimization algorithm provided in a related technology is as follows: In a graphics processing unit (GPU) cluster, an original MAML algorithm is parallelized based on a collective communication primitive AllReduce. Specifically, a GPU memory of each device in the cluster accommodates all parameters of a model. However, a quantity of embedding layer parameters of a DLRM is large, and cannot be accommodated in a single GPU memory of most models in the industry.

A meta learning method of a deep learning model and a meta learning system of a deep learning model provided in the embodiments of this specification can resolve the above-mentioned problem. In a meta learning solution of a deep learning model provided in the embodiments of this specification, each processing node executes a training task by using some training samples, to implement parallel training of training data. In addition, each processing node is responsible for learning some parameters of the model, to implement parallel training of the model. Therefore, the embodiments of this specification provide a hybrid parallel meta learning manner, to reduce graphics memory redundancy, help improve meta learning efficiency of the deep learning model, and avoid a problem that a single processing node cannot accommodate a to-be-learned parameter (for example, an embedding layer parameter of a DLRM).

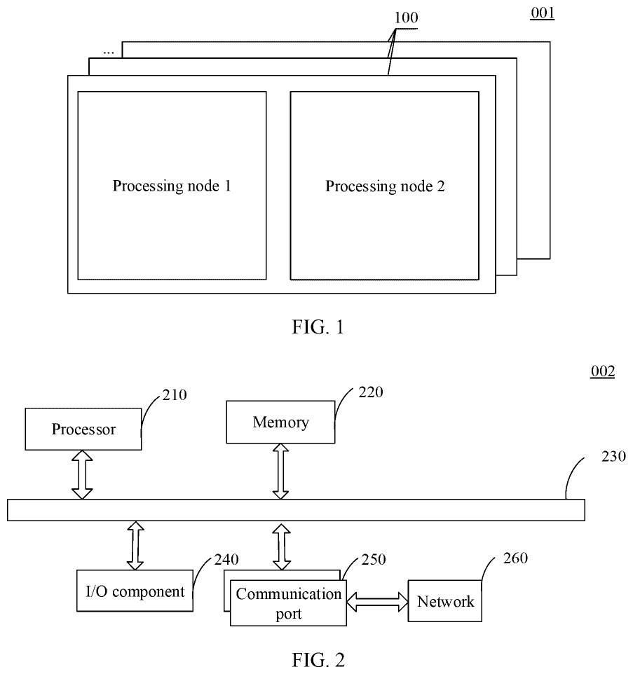

With reference to FIG. 1 to FIG. 8, the following describes in detail a meta learning system of a deep learning model and a meta learning method of a deep learning model provided in the embodiments of this specification.

FIG. 1 is a schematic diagram of a meta learning system 001 of a deep learning model according to an embodiment of this specification. For ease of description, the meta learning system 001 of a deep learning model is briefly referred to as a system 001 below in this specification. The system 001 can be a cluster system including one or more entity devices 100. Therefore, the system 001 can also be referred to as a cluster 001. One or more processing nodes (for example, a processing node i and a processing node j) can be deployed on each entity device 100. The system 001 can perform a meta learning method of a deep learning model described in this specification. The meta learning method of a deep learning model is described in another part of this specification.

FIG. 2 is a schematic structural diagram of a computing device 002 according to some embodiments of this specification. The computing device 002 can serve as any entity device 100 in FIG. 1. The computing device 002 can be a general-purpose computer or a dedicated computer. For example, the computing device 002 can be a server, a personal computer, or a portable computer (for example, a notebook computer or a tablet computer), or can be another device with a computing capability.

The computing device 002 in this specification can include one or more of the following components: a processor 210, a memory 220, a bus 230, an I/O component 240, and a communication port 250. The processor 210, the memory 220, the I/O component 240, and the communication port 250 can be connected through the bus 230.

The processor 210 can include one or more processing cores. The processor 210 is connected to all parts of the entire computing device 002 through various interfaces and lines, and runs or executes instructions, a program, a code set, or an instruction set stored in the memory 220, and invokes data stored in the memory 220, to perform a meta learning method of a deep learning model described in this specification. Optionally, the processor 210 can integrate one or a combination of several of a graphics processing unit (GPU), a central processing unit (CPU), a modem, etc. The processor 210 can be implemented in at least one hardware form of a digital signal processor (DSP), a field-programmable gate array (FPGA), or a programmable logic array (PLA). The modem is configured to process wireless communication. It can be understood that the modem does not need to be integrated into the processor 210, and is separately implemented by using a communication chip.

It should be noted that, in this embodiment of this specification, the processor 210 can serve as a processing node (worker). Specifically, at least one processing node (worker) is deployed on each computing device 002. For example, as shown in FIG. 1, two processing nodes, that is, a processing node 1 (worker1) and a processing node 2 (worker 2) are deployed on the entity device 100. Therefore, to merely describe a problem, only one processor 210 in the computing device 002 in FIG. 2 is described. The computing device 002 in this specification can further include a plurality of processors. Therefore, operations and/or method steps disclosed in this specification can be performed by one processor or can be jointly performed by a plurality of processors as described in this specification. For example, if the processor 210 in the computing device 002 in this specification performs step A and step B, it should be understood as that step A and step B can be jointly or separately performed by two different processors 210 (for example, a first processor performs step A, and a second processor performs step B, or a first processor and a second processor jointly perform step A and step B).

The memory 220 can be a non-transitory storage medium, or can be a transitory storage medium. For example, the memory 220 can include one or more of a flash memory, a disk, a read-only memory (ROM), and a random access memory (RAM). The memory 220 can be configured to store instructions, a program, code, a code set, or an instruction set. The memory 220 can include a program storage area and a data storage area. The program storage area can store instructions used to implement an operating system, instructions used to implement at least one function (for example, a touch function, a sound play function, or an image play function), instructions used to implement the following method embodiments, etc. The operating system can be a HarmonyOS system and an Android system, including a system deeply developed based on the Android system, an IOS system, and including a system deeply developed based on the IOS system and another system.

The processor 210 can be communicatively connected to the memory 220 through the internal communication bus 230. The processor 210 is configured to execute at least one instruction set stored in the memory 220. When the computing device 002 runs, the at least one processor 220 reads the at least one instruction set, and performs, based on an indication of the at least one instruction set, the meta learning method of a deep learning model provided in this specification. The processor 220 can perform all or some steps included in the meta learning method of a deep learning model.

The I/O component 240 supports an input/output between the computing device 002 and another component. For example, instructions or data are input by using the I/O component 240, and an input device includes but is not limited to a keyboard, a mouse, a camera, a microphone, or a touch device. For another example, instructions or data are output by using the I/O component 240, and an output device includes but is not limited to a display device, a speaker, etc. In an example, the output device can be a display. For example, a model parameter determined according to the solution in this specification is displayed on the display.

The communication port 250 is used for data communication between the computing device 002 and the outside. For example, the communication port 250 can be used for data communication between the computing device 002 and a network 260. The communication port 250 can be a wired communication port, or can be a wireless communication port.

In addition, a person skilled in the art can understand that a structure shown in the accompanying drawings does not constitute a limitation on the computing device 002, and the computing device 002 can include more or fewer components than those shown in the figure, or combine some components, or have different component arrangements. For example, the computing device 002 further includes components such as a radio frequency circuit, an input unit, a sensor, an audio circuit, a wireless fidelity (Wi-Fi) module, a power supply, and a Bluetooth module. Details are omitted here for simplicity.

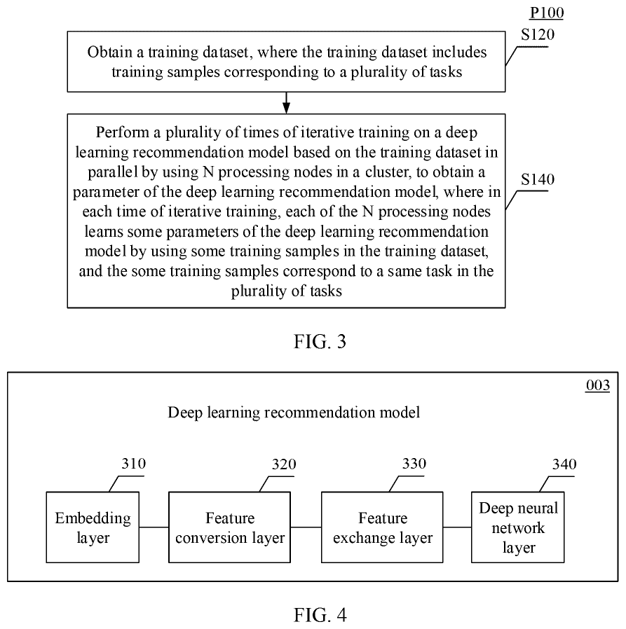

FIG. 3 is a schematic flowchart of a meta learning method P100 of a deep learning model according to an embodiment of this specification. As described above, a system 001 can perform the meta learning method P100 of a deep learning model in this specification. Specifically, a computing device 002 can read an instruction set stored in a local storage medium of the computing device 002, and then perform, based on a stipulation of the instruction set, the meta learning method P100 of a deep learning model in this specification. As shown in FIG. 3, the meta learning method P100 of a deep learning model can include:

S120: Obtain a training dataset, where the training dataset includes training samples corresponding to a plurality of tasks.

In an example embodiment, three tasks are used as an example. It is assumed that a task 1 is an advertisement a release task, a task 2 is an advertisement b release task, and a task 3 is an advertisement c release task. If a sample quantity of the task 2 is relatively small, a model used for advertisement b release prediction faces a cold start problem. In this embodiment of this specification, samples of the three different tasks of the task 1, the task 2, and the task 3 are used as training samples, to perform meta learning on the deep learning model. The system 001 learns from a series of different tasks of the task 1 to the task 3, to extract inter-task generality and a pattern. In this way, the model can learn of a capability of “learning how to learn”, so that when facing, for example, the task 2, the model can adapt and resolve a problem more quickly based on learned knowledge and experience. It can be learned that meta learning aims to enable the deep learning model to learn how to quickly learn when facing the task 2, so that the model used for advertisement b release prediction faces the cold start problem.

In this embodiment of this specification, the training samples respectively corresponding to the plurality of tasks are used to determine the training dataset of meta learning.

As shown in FIG. 3, the meta learning method P100 of a deep learning model can further include:

S140: Perform a plurality of times of iterative training on the deep learning model based on the training dataset in parallel by using N processing nodes in a cluster, to obtain a parameter of the deep learning model, where in each time of iterative training, each of the N processing nodes learns of some parameters of the deep learning model by using some training samples in the training dataset, and the some training samples correspond to a same task in the plurality of tasks.

In an example embodiment, the meta learning method of a deep learning model provided in this specification is applied to the cluster (for example, the system 001) including the N processing nodes. Specifically, after the training dataset including the training samples respectively corresponding to the plurality of tasks is obtained, the plurality of times of iterative training are performed on the deep learning model based on the training dataset in parallel by using the N processing nodes (worker) in the cluster 001, to obtain a meta learning parameter of the deep learning model. In each time of iterative training, the parameter of the deep learning model is distributed on each processing node in the cluster, and each processing node learns of some parameters of the deep learning model by using some training samples in the training dataset.

In an example embodiment, the deep learning model can be a DLRM. FIG. 4 is a schematic structural diagram of a deep recommendation model 003 according to an embodiment of this specification. As shown in FIG. 4, a DLRM includes an embedding layer 310, a feature conversion layer 320, a feature exchange layer 330, and a deep neural network layer 340. The embedding layer 310 is a layer of network structure that converts high-dimensional sparse discrete features into low-dimensional dense continuous features. In a recommendation system, a large scale of user and article features usually need to be processed, and these features are discrete, for example, a user ID and an article ID. These features are directly input to a neural network, leading to excessive network parameters and high computing complexity, and also affecting a generalization capability of the model. Usually, a parameter quantity of the embedding layer 310 is large, for example, is up to dozens of GB, or hundreds of thousands of GB. A network structure part other than the embedding layer 310 usually has a relatively small parameter quantity, for example, several GB. In this embodiment of this specification, a parameter of the embedding layer 310 is denoted as an “embedding layer parameter”, and a parameter of a structure other than the embedding layer 310 of the DLRM is denoted as a “dense layer parameter”.

In an example embodiment of this specification, because a quantity of embedding layer parameters is large, the embedding layer parameters can be split into a plurality of processing nodes, so that each processing node learns some of the embedding layer parameters of the model. In another example embodiment, dense layer parameters can also be split into a plurality of processing nodes. This is not limited in this specification.

It can be understood that the deep learning model can be another deep learning model different from the DLRM. This is not limited in this specification.

In the meta learning method P100 of a deep learning model shown in FIG. 3, each processing node executes a training task by using some training samples, to implement parallel training of training data. In addition, each processing node is responsible for learning some parameters of the model, to implement parallel training of the model. Therefore, this embodiment of this specification provides a hybrid parallel meta learning manner, to reduce graphics memory redundancy and help improve meta learning efficiency of the deep learning model. In addition, a problem that a single processing node cannot accommodate a to-be-learned parameter (for example, the embedding layer parameter of the DLRM) in the above-mentioned related technology can be avoided.

It should be noted that before the method P100 shown in FIG. 3 is performed, data preprocessing needs to be performed first.

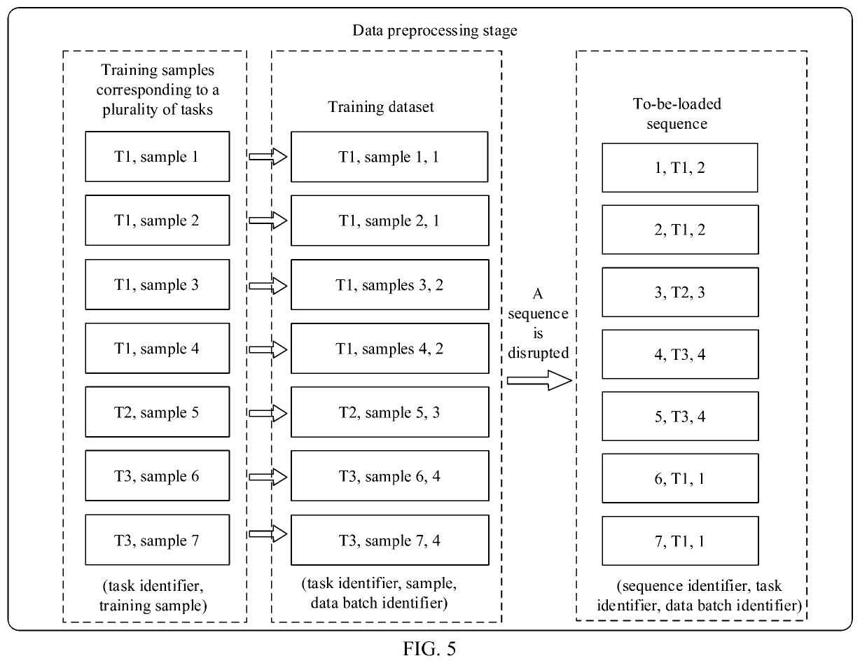

FIG. 5 is a schematic flowchart of data preprocessing according to an embodiment of this specification. In this embodiment of this specification, each sample includes a task identifier (task_id) of a task to which the sample belongs. As shown in FIG. 5, a sample 1 to a sample 4 each carry a task identifier “T1” of a task to which the sample 1 to the sample 4 belong. In other words, the sample 1 to the sample 4 are all samples of a task T1. Similarly, a sample 5 carries a task identifier “T2” of a task to which the sample 5 belongs, and it indicates that the sample 5 is a sample of a task T2; a sample 6 and a sample 7 carry a task identifier “T3” of a task to which the sample 6 and the sample 7 belong, and it indicates that the sample 6 and the sample 7 are samples of a task T3.

In a data preprocessing stage, training samples respectively corresponding to P tasks are determined. Each training sample includes a task identifier of a task to which the training sample belongs, and P is an integer greater than 1. Further, the training samples respectively corresponding to the P tasks are split into Q data batches based on a predetermined batch size, to obtain a training dataset. Task identifiers of training samples belonging to a same data batch are consistent, and Q is an integer greater than P.

In a process in which each processing node performs each time of iterative training, data required by each processing node are at least one data batch. A size of the data batch is determined based on an actual situation. Therefore, training samples respectively corresponding to a plurality of tasks need to be divided into a plurality of data batches. As shown in FIG. 5, the training samples corresponding to the plurality of tasks can be first sorted based on task identifiers task_id, and then, the samples can be split into four data batches based on the predetermined batch size in a sequence in which task identifiers (task_id) are sorted. Each data batch can carry both a data batch identifier (batch_id) and the task identifier (task_id). Specifically, as shown in a second column in FIG. 5, a data batch 1 includes the sample 1 and the sample 2, a data batch 2 includes the sample 3 and the sample 4, a data batch 3 includes the sample 5, and a data batch 4 includes the sample 6 and the sample 7. It can be learned that samples belonging to the same data batch come from the same task. Therefore, after the data batch is loaded to the processing node, it can be ensured that training samples required by the processing node in a process of one time of iterative training belong to the same task.

For example, because a sample quantity in an ASR scenario is large, a sample can be stored in an hdd-based file system, for example, a hadoop distributed file system (HDFS), to effectively reduce costs. In addition, a character string-based storage format has a high decoding time-consuming problem, resulting in a considerable delay in a process in which the processing node loads a sample. Therefore, in an example embodiment of this specification, a data format TFRecords of an artificial intelligence software library Tensorflow is used as a storage format, or a data format TFRecords of an artificial intelligence software library Tensorflow and a data loading library WebDataset in an open-source deep learning framework PyTorch can be used as a storage format to accelerate deserialization, to reduce data transmission, and reduce a delay generated in the process in which the processing node loads the sample.

Still as shown in FIG. 5, in the data preprocessing stage, a sequence of the determined training dataset can be disrupted, to obtain a to-be-loaded sequence, so as to effectively load a large quantity of kb-level small samples, In the to-be-loaded sequence, all samples are stored in a sequence of sequence identifiers (offset). In this case, when the processing node loads training data, the sample can be loaded to each worker i based on (offset*i, offset*i+total_samples/N). In the above-mentioned sequential read access manner provided in this embodiment of this specification, there is a relatively high I/O throughput in a block-based file system.

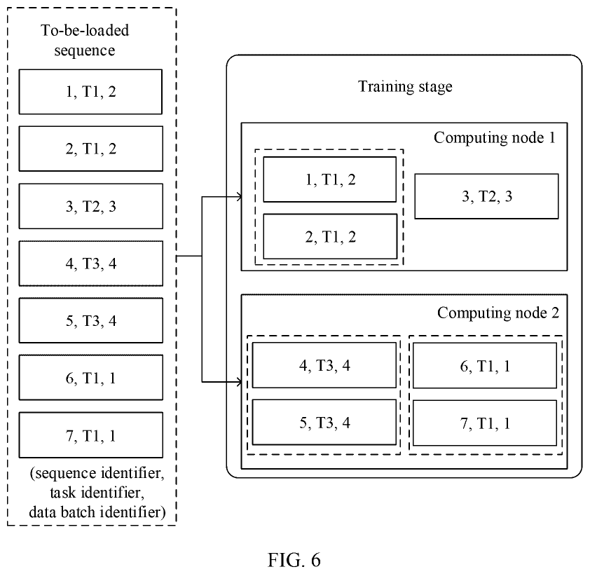

In an example embodiment, in a training stage in which the processing node performs meta learning, each worker can integrate samples from the same task in batches based on the task identifier task_id and the data batch identifier batch_id, so that all workers uniformly load samples. For example, as shown in FIG. 6, a worker 1 performs loading to obtain the data batch 2 and the data batch 3, and the worker 2 performs loading to obtain the data batch 4 and the data batch 1.

Through data preprocessing shown in FIG. 5, the training samples corresponding to the plurality of tasks can be converted into the training dataset, and further, the to-be-loaded sequence can be further determined. The training dataset or the to-be-loaded sequence includes the plurality of data batches, and samples in the same data batch come from the same task. Therefore, each processing node in a cluster 001 can load the data batch in the training dataset, to execute the training stage of meta learning.

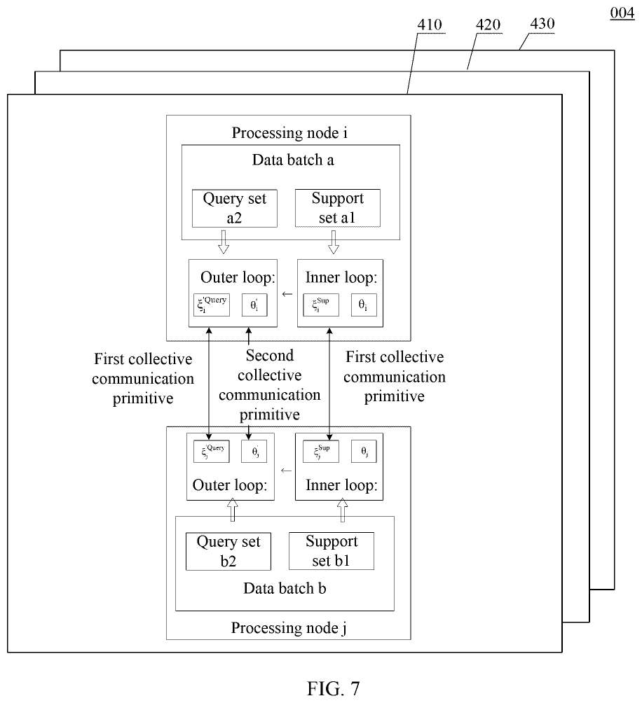

FIG. 7 is a schematic diagram of a meta learning framework 004 of a deep learning model according to an embodiment of this specification. A cluster for performing a meta learning method of a deep learning model can include a plurality of entity devices such as 410 to 430. For example, at least one processing node (worker) is deployed on each entity device. For example, as shown in FIG. 7, two processing nodes are deployed on the entity device 410, and are respectively a processing node i (worker i) and a processing node j (worker j).

In an example embodiment, the processing node can be a GPU or a CPU. Because the GPU can perform the above-mentioned distributed training to provide sufficient computing performance and a sufficient network bandwidth, an example in which all processing nodes are GPUs is used for description in this embodiment of this specification, to improve meta learning training efficiency of the deep learning model.

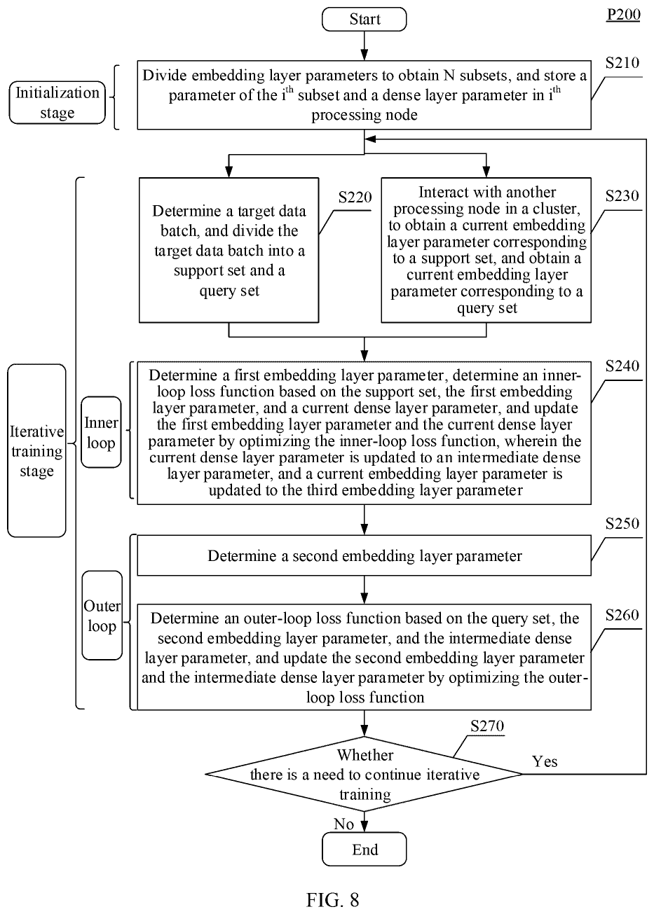

In a meta learning process of the deep learning model, that each processing node performs one time of iterative training includes: performing an inner loop training process and then performing an outer loop training process. Both the inner loop training process and the inner loop training process need two aspects of data. One aspect is training data required for a current time of iterative training, namely, a data batch, and the other aspect is a to-be-learned model parameter in the current time of iterative training. Specifically, as shown in FIG. 7, the worker i is used as an example. In an inner loop training process of one time of iterative training, a training sample in a data batch a needs to be determined, and to-be-learned model parameters ξᵢ^{Sup} and θᵢ need to be determined. An embodiment of determining training data (namely, a data batch) required for a current iteration process is described in detail above. Details are omitted here for simplicity. With reference to the embodiment provided in FIG. 8, the following describes an embodiment of determining a to-be-learned model parameter in an iteration process.

FIG. 8 is a schematic flowchart of a meta learning method P200 of a deep learning model according to an embodiment of this specification. Any processing node in a cluster 001 can perform a meta learning method P200 of a deep learning model in this specification. Specifically, the any processing node in the cluster 001 can read an instruction set stored in a local storage medium of the cluster 001, and then perform, based on a stipulation of the instruction set, the meta learning method P200 of a deep learning model in this specification. As shown in FIG. 8, the method P200 includes the following steps.

In an initialization stage (that is, before the processing node performs iterative training), S210 is performed: Divide an embedding layer parameter, to obtain N subsets; and store a parameter in the i^{th} subset and a dense layer parameter in the i^{th} processing node, where a value of i is a positive integer less than or equal to N.

In this embodiment provided in this specification, because a quantity of embedding layer parameters is large, the any processing node in the cluster 001 can divide all embedding layer parameters into a plurality of subsets, so that each worker is responsible for a parameter corresponding to one subset, namely, some embedding layer parameters. In addition, in the initialization stage, because a quantity of dense layer parameters is relatively small, each worker stores a complete copy of the dense layer parameters and is responsible for learning all dense layer parameters of the model.

In addition, a step hyperparameter α in inner loop training and an outer loop step hyperparameter β are further set in the initialization stage, and N in the following formula still represents a quantity of processing nodes in the cluster.

As shown in FIG. 8, the method P200 further includes: performing S220 to S260 in a process in which the processing node performs one time of iterative training.

S220: Determine a target data batch, and divide the target data batch into a support set and a query set.

In an example embodiment, as shown in FIG. 5 and FIG. 6, a to-be-loaded sequence is obtained after a training dataset is disrupted. Further, data batches in the to-be-loaded sequence are uniformly loaded to all processing nodes. For example, as shown in FIG. 6, a sample loaded to a worker 1 is a data batch 2 belonging to a task 1 and a data batch 3 belonging to a task 2. In S220, the worker 1 can determine that the data batch 2 belonging to the task 1 is the target data batch, or the worker 1 can determine that the data batch 3 belonging to the task 2 is the target data batch.

Further, if the worker 1 determines that the data batch 3 belonging to the task 2 is the target data batch, the data batch 3 is further divided into two parts. A part of the samples is recorded as a support set, and another part of the samples is recorded as a query set. The support set is used for inner loop training in a current iterative training process, and the query set is used for outer loop training in the current iterative training process. A worker i is used as an example for description. A specific iteration loop of the processing node corresponds to a target data batchBᵢ. Further, the target data batch is split into a support set Dᵢ^{Sup} and a query set Dᵢ^{Query} Specifically, the worker i can equally split the target data batch Bᵢ, to obtain the support set Dᵢ^{Sup} and the query set Dᵢ^{Query}. Alternatively, another preset split manner can be used. A specific implementation of splitting the target data batch into the support set and the query set is not limited in this embodiment of this specification.

For example, as shown in FIG. 7, the target data batch determined by the worker i is a data batch a. Further, the data batch a is divided into a support set a1 and a query set a2. The target data batch determined by the worker j is a data batch b. Further, the data batch b is divided into a support set b1 and a query set b2.

S230: Interact with another processing node in the cluster, to obtain a current embedding layer parameter corresponding to the support set, and obtain a current embedding layer parameter corresponding to the query set.

The worker i is used as an example for description. Because all processing nodes in the cluster 001 jointly learn the embedding layer parameter of the model, the worker i node may not exist in an embedding layer parameter corresponding to the support set Dᵢ^{Sup} in a current inner loop training process of the worker i. Therefore, communication needs to be performed with the another processing node in the cluster 001, to obtain the embedding layer parameter stored in the another processing node. For example, as shown in FIG. 7, before the above-mentioned data interaction is performed, the worker i node may not exist in an embedding layer parameter corresponding to a support set a1 of the worker i. Therefore, communication needs to be performed with the another processing node (including the processing node j shown in FIG. 7) in the cluster 001, to obtain the embedding layer parameter stored in the another processing node, for example, ξᵢ^{Sup} shown in FIG. 7. Similarly, as shown in FIG. 7, the worker j node may not exist in an embedding layer parameter corresponding to a support set b1 of the worker j. Therefore, communication needs to be performed with the another processing node (including the processing node i shown in FIG. 7) in the cluster 001, to obtain the embedding layer parameter stored in the another processing node, for example, Sup shown in FIG. 7.

In an example embodiment, when the processing node is a GPU, communication is performed by using a collective communication primitive AlltoAll, to fully use a bandwidth between workers. Specifically, the collective communication primitive AlltoAll is executed to exchange an embedding layer parameter between all workers, so that the worker i obtains the embedding layer parameter ξᵢ^{Sup} that needs to be learned in an inner loop process. In addition, the embedding layer parameter ξᵢ^{Query} that needs to be learned is further obtained in advance for a query set in an outer loop process in the current iterative training. In this embodiment of this specification, as shown in FIG. 7, the collective communication primitive AlltoAll is executed for one time, and the current embedding layer parameter ξᵢ^{Sup} corresponding to the support set Dᵢ^{Sup} in the inner loop training process and the current embedding layer parameter ξᵢ^{Query} corresponding to the query set Dᵢ^{Query} in the outer loop training process are obtained for the worker i. In this embodiment of this specification, two communication-intensive embedding lookup operations are aggregated, to effectively reduce a communication frequency.

S240: Determine a first embedding layer parameter, determine an inner-loop loss function based on the support set, the first embedding layer parameter, and a current dense layer parameter, and update the first embedding layer parameter and the current dense layer parameter by optimizing the inner-loop loss function, where the current dense layer parameter is updated to an intermediate dense layer parameter, and the first embedding layer parameter is updated to the third embedding layer parameter.

The training process described in S240 can also be referred to as the inner loop training process. The first embedding layer parameter corresponds to at least some parameters in the embedding layer parameter. In the inner loop training process, the first embedding layer parameter and the dense layer parameter are updated. In some embodiments, the current embedding layer parameter corresponding to the support set can be determined as the first embedding layer parameter. For example, the first embedding layer parameter determined by the worker i in FIG. 7 is ξᵢ^{Sup}, and the first embedding layer parameter determined by the worker j is ξᵢ^{Sup}. In some embodiments, the current dense layer parameter can be a dense layer parameter stored in the processing node in S210. For example, the current dense layer parameter determined by the worker i in FIG. 7 is θᵢ, and the current dense layer parameter determined by the worker j is θᵢ. It can be understood that, θᵢ and θᵢ are exactly the same as before updating, and are only copies.

Specifically, the worker i performs forward computation based on the support set Dᵢ^{Sup}, the current embedding layer parameter ξᵢ^{Sup} corresponding to the support set Dᵢ^{Sup}, and the current dense layer parameter θᵢ, to determine an inner-loop loss function Lᵢ^{Sup}, for example, Formula (1):

$${L}_{i}^{Sup} ← L ( f ( {ξ}_{i}^{Sup} , {θ}_{i} ; {D}_{i}^{Sup} ) ) \qquad ( 1 )$$

Further, local gradient backward propagation is performed on the inner-loop loss function Lᵢ^{Sup}, to update the first embedding layer parameter and the current dense layer parameter. Specifically, the current embedding layer parameter ξᵢ^{Sup} (namely, the first embedding layer parameter) corresponding to the support set Du is updated to obtain the third embedding layer parameter ξᵢ^{Sup}, and the current dense layer parameter θᵢ is updated to obtain the intermediate dense layer parameter θ′ᵢ, for example, Formula (2) and Formula (3):

$${ξ}_{i}^{′ Sup} ← {ξ}_{i}^{Sup} ← α {∇}_{{ξ}_{i}^{Sup}} {L}_{i}^{Sup} \qquad ( 2 )$$

$${θ}_{i}^{′} ← {θ}_{i} ← α {∇}_{{θ}_{i}} {L}_{i}^{Sup} \qquad ( 3 )$$

Therefore, after performing the above-mentioned inner loop training, the worker i obtains task-specific model parameters ξ′ᵢ^{Sup} and θ′ᵢ. The specific task is a task to which the target data batch Bᵢ belongs.

Further, the iterative training process further includes outer loop training: The worker i performs local forward computation and local backward computation based on the query set Dᵢ^{Query} and the embedding layer parameter and the dense layer parameter that are required by the query set Dᵢ^{Query} The worker i performs global gradient updating based on the training data, and can determine a parameter after the deep learning model is updated after the current iterative training process, that is, can obtain a meta learning parameter [ξ, θ] of the model after the current time of iterative training. As shown in FIG. 8, the outer loop training process specifically includes S250 and S260.

S250: Determine a second embedding layer parameter.

In deep learning, a stale gradient problem is that when a network parameter update speed is too slow, information synchronization is not updated in a timely manner, resulting in outdated gradient information, and affecting a network training effect. In this embodiment of this specification, to avoid the stale gradient problem, the current embedding layer parameter ξᵢ^{Query} corresponding to the query set Dᵢ^{Query} in the S230 is not directly determined as a parameter that needs to be updated in outer loop training. Instead, whether the support set Dᵢ^{Sup} and the query set Dᵢ^{Query} of the current iterative training have an overlapping element is first learned through comparison. The above-mentioned element can be a feature value, and that two samples have an overlapping element represents that the two samples have a same feature value. For example, if a sample S1 in the query set Dᵢ^{Sup} is “Shanghai, female, and hand bag”, and a sample S10 in the query set Dᵢ^{Query} is “Shanghai, male, and razor”, the support set Dᵢ^{Sup} and the query set Dᵢ^{Query} have an overlapping element. To be specific, the feature value “Shanghai” in the sample S10 in the query set overlaps the feature value “Shanghai” in the sample S1 in the support set. When the support set Dᵢ^{Sup} and the query set Dᵢ^{Query} have an overlapping element, for an embedding layer parameter corresponding to the overlapping element in the training sample of the query set, the third embedding layer parameter ξ′ᵢ^{Sup}, obtained through updating in the inner loop training process is determined as the second embedding layer parameter ξ′ᵢ^{Query} to be updated in the outer loop training process. For example, the third embedding layer parameter corresponding to the feature value “Shanghai” in the updated sample S1 in the inner loop training process is determined as the second embedding layer parameter corresponding to the feature value “Shanghai” in the sample S10 in the query set. This manner facilitates the parameter update speed in the outer loop process, and helps update the synchronization information in a timely manner, to resolve the stale gradient problem. In addition, for an embedding layer parameter corresponding to a non-overlapping element in the training sample of the query set, the current embedding layer parameter corresponding to the query set is determined as the second embedding layer parameter. For example, the sample S10 of the query set further includes the feature value “razor”, but none of training samples of the support set includes the feature value. In this case, if the sample S10 of the query set includes the feature value “razor”, the current embedding layer parameter that corresponds to the query set and that is obtained in advance in S230 is used. When the support set Dᵢ^{Sup} and the query set Dᵢ^{Query} has no overlapping element, the current embedding layer parameter ξᵢ^{Query} (that is, the current embedding layer parameter obtained in advance by using the collective communication primitive in S230) corresponding to the query set Dᵢ^{Query} is determined as the second embedding layer parameter ξ′ᵢ^{Query}.

For example, as shown in FIG. 7, when a query set a2 and a support set a1 have an overlapping element, the third embedding layer parameter ξ′ᵢ^{Sup} obtained by the worker i through inner loop training is determined as a to-be-learned second embedding layer parameter in an outer loop, which is specifically ξ′ᵢ^{Query}. To avoid the stale gradient problem, when the query set a2 and the support set a1 have no overlapping element, the current embedding layer parameter ξᵢ^{Query} obtained in advance by using the collective communication primitive in S230 is determined as the second embedding layer parameter ξ′ᵢ^{Query}. Similarly, as shown in FIG. 7, when a query set b2 and a support set b1 have an overlapping element, the third embedding layer parameter ξ′ᵢ^{Sup} obtained by the worker j through inner loop training is determined as a to-be-learned second embedding layer parameter in an outer loop, which is specifically ξ′ᵢ^{Query}. To avoid the stale gradient problem, when the query set b2 and the support set b1 have no overlapping element, the current embedding layer parameter ξᵢ^{Query} obtained in advance by using the collective communication primitive in S230 is determined as the second embedding layer parameter ξ′ᵢ^{Query}.

S260: Determine an outer-loop loss function based on the query set, the second embedding layer parameter, and the intermediate dense layer parameter, and update the second embedding layer parameter and the intermediate dense layer parameter by optimizing the outer-loop loss function.

For example, the to-be-learned dense layer parameter in outer loop training is a dense layer parameter obtained through learning in an inner loop. As shown in FIG. 7, a dense layer parameter θ′ᵢ to be learned by the worker i in outer loop training can be specifically an intermediate dense layer parameter θ′ᵢ obtained by the worker i through learning in an inner loop. Similarly, a dense layer parameter θ′ⱼ to be learned by the worker j in outer loop training can be specifically an intermediate dense layer parameter θ′ⱼ obtained by the worker j through learning in an inner loop.

Specifically, the worker i performs forward computation based on the query set Dᵢ^{Query}, the second embedding layer parameter ξ′ᵢ^{Query}, and the intermediate dense layer parameter θ′ᵢ, to determine an outer-loop loss function Lᵢ^{Query}, for example, Formula (4):

$${L}_{i}^{Query} ← L ( f ( {ξ}_{i}^{′ Query} , {θ}_{i}^{′} ; {D}_{i}^{Query} ) ) \qquad ( 4 )$$

Further, the embedding layer parameter of the deep learning model or the DLRM after the current time of iterative training is determined in S1 to S4. S1: The worker i computes a gradient of the outer-loop loss function Lᵢ^{Query} with respect to the embedding layer parameter ξ, to obtain a sub-embedding layer gradient corresponding to the worker i, for example, Formula (5):

$${∇}_{ξ} {L}_{i}^{Query} \qquad ( 5 )$$

S2: The worker i interacts with another processing node in the cluster, to obtain a sub-embedding layer gradient corresponding to the another processing node in the cluster.

For example, when each processing node is a GPU, as shown in FIG. 7, interaction can be performed with the another processing node in the cluster by using a first collective communication primitive AlltoAll, to obtain the sub-embedding layer gradient corresponding to the another processing node in the cluster.

S3: Perform aggregation computation on obtained sub-embedding layer gradients, to obtain a target embedding layer gradient. S4: Update the second embedding layer parameter based on the target embedding layer gradient, to obtain an embedding layer element learning parameter corresponding to the i^{th} processing node after the current time of iterative training, for example, Formula (6):

$$ξ ← ξ ← β {\sum }_{i = 1}^{N} {∇}_{ξ} {L}_{i}^{Query} \qquad ( 6 )$$

The embedding layer parameters respectively corresponding to the N processing nodes in the cluster form the embedding layer parameter of the deep learning model or the DLRM. It can be understood that the embedding layer parameter obtained after outer loop training is a meta learning parameter of the embedding layer in the model.

Next, the dense layer parameter of the deep learning model or the DLRM after the current time of iterative training is determined in S1′ to S4′. S1′: The worker i computes a gradient of the outer-loop loss function with respect to the dense layer parameter, to obtain a sub-dense layer gradient corresponding to the worker i, for example, Formula (7):

$${∇}_{θ} {L}_{i}^{Query} \qquad ( 7 )$$

S2: The worker i interacts with another processing node in the cluster, to obtain a sub-dense layer gradient corresponding to the another processing node in the cluster.

For example, when each processing node is a GPU, as shown in FIG. 7, interaction can be performed with the another processing node in the cluster by using a second collective communication primitive AllReduce, to obtain the sub-dense layer gradient corresponding to the another processing node in the cluster.

S3: Perform aggregation computation on obtained sub-dense layer gradients, to obtain a target dense layer gradient. S4: Update the intermediate dense layer parameter based on the target dense layer gradient, to obtain a dense layer element learning parameter corresponding to the i^{th} processing node after the current time of iterative training, for example, Formula (8):

$$θ ← θ ← β {\sum }_{i = 1}^{N} {∇}_{θ} {L}_{i}^{Query} \qquad ( 8 )$$

A dense layer parameter corresponding to each processing node in the cluster is a dense layer parameter of the deep learning model or the DLRM. It can be understood that the dense layer parameter obtained after outer loop training is a meta learning parameter of the dense layer in the model.

It should be noted that a manner of updating the embedding layer parameter and the dense layer parameter in the outer loop training process based on a conventional MAML algorithm is separately as shown in Formula (9) and Formula (10):

$$ξ ← ξ ← β {∇}_{ξ} {\sum }_{i = 1}^{N} {L}_{i}^{Query} \qquad ( 9 )$$

$$θ ← θ ← β {∇}_{θ} {\sum }_{i = 1}^{N} {L}_{i}^{Query} \qquad 10 )$$

It can be learned that in the conventional MAML algorithm, a central node needs to execute ∇_{θ}Σᵢ₌₁^{M}Lᵢ^{Query}, and update the meta learning parameter. In this embodiment of this specification, sequences of a gradient and a summation operator can be changed based on a derivative rule, to obtain Formula (6) and Formula (8). Therefore, in this embodiment of this specification, the worker can locally compute gradients, and then aggregate the gradients into the meta learning parameter by using the collective communication primitive. Therefore, compared with the conventional MAML algorithm, in the solution provided in this embodiment of this specification, a data amount of transmission in the outer loop training process is reduced, and computing complexity is reduced, to improve meta learning efficiency of the deep learning model.

Still as shown in FIG. 8, the worker i performs S220 to S260 to complete one time of iterative training, and performs S270 to determine whether to continue iterative training. If S220 to S260 need to be repeatedly performed, until it is determined in S270 that iterative training does not need to be continued, [ξ, θ] determined in a final time of iterative training is a meta learning parameter of the deep learning recommendation model.

It should be noted that the above-mentioned hybrid parallel algorithm can implement parallel training of a large meta DLRM. Because the collective communication primitives AlltoAll and AllReduce are highly connected communication modes, a socket-based network in a data center hinders communication efficiency. Therefore, to avoid network congestion that affects a meta learning computing speed, in this embodiment of this specification, data transmission is performed between different entity devices through remote direct memory access (RDMA), to implement scalable high-speed communication. For data transmission deployed between internal processing nodes of the same entity device, a high-speed connection channel NVLink is used to replace a peripheral component interconnect express (PCIe) bus (for example, a system memory), to obtain a higher bandwidth.

Compared with a distributed training architecture parameter server provided in a related technology, in a distributed communication topology provided in the solution provided in this embodiment of this specification, a server node is no longer used, but a bandwidth between worker nodes is fully used, so that distributed training can be efficiently performed on a GPU cluster. Compared with parallelizing the original MAML algorithm based on the collective communication primitive AllReduce in the related technology, in the solution provided in this embodiment of this specification, the embedding layer parameters in the large-scale sparse model are split into different processing nodes, to resolve a problem that a GPU memory of a single device cannot accommodate the embedding layer parameters. Then, the collective communication primitive AlltoAll is used to perform collective communication based on a high bandwidth of optimized networks (NVLink and RDMA), to ensure computing performance and communication efficiency. In addition, in the solution provided in this embodiment of this specification, in a process of each time of iterative training, two communication-intensive embedding lookup operations are aggregated, to effectively reduce a communication frequency. In the process of one time of iterative training, if the support set and the query set have an overlapping element, the embedding layer parameter determined through inner cycle training is used as the embedding layer parameter to be learned through inner cycle training, to avoid a problem that a stale gradient affects a model effect. In addition, the solution provided in this embodiment of this specification further optimizes an update formula in the outer loop training process, so that a communication amount and computing complexity are greatly reduced, and a training speed is indirectly improved.

In conclusion, according to the meta learning method of a deep learning model and the meta learning system of a deep learning model in the embodiments of this specification provide, the embodiments of this specification provide a set of meta learning distributed algorithms and solutions for training a large-scale distributed sparse model on a GPU cluster, and introduce distributed training of hybrid parallel meta learning for the first time. The distributed algorithm in the embodiments of this specification provides a series of optimizations for targeted computing efficiency and communication efficiency for features of meta learning and sparse deep learning models, for example, a distributed algorithm, an operator combination, an outer loop optimization, and a network optimization. In addition, training efficiency is improved, to increase training data and a quantity of tasks, so that a model effect obtained through training is improved. For example, compared with using a parameter server architecture on a CPU, in the solution provided in the embodiments of this specification, a training speed can be accelerated by 22%, and computational overheads are reduced by 62.29%. For another example, in a home page display advertisement on a platform, an online experiment result indicates that, compared with a related technology, in the solution provided in the embodiments of this specification, a model delivery time is reduced from 3.7 hours to 1.2 hours by using 1.6 billion samples, and a conversion rate (CVR) and a cost per mile (CPM) of a trained model are respectively increased by 6.48% and 1.06%. A model effect benefit mainly comes from supporting a larger training sample and more tuple learning tasks.

Another aspect of this specification provides a non-transitory storage medium, storing at least one group of executable instructions used to perform signal processing. When the executable instructions are executed by a processor, the executable instructions instruct the processor to implement the steps of the meta learning method P100 of a deep learning model in this specification. In some possible implementations, aspects of this specification can further be implemented in a form of a program product, including program code. When the program product runs on an acoustic system, the program code is used to enable the acoustic system to perform the steps of the meta learning method P100 of a deep learning model in this specification. The program product configured to implement the above-mentioned method can be a portable compact disc read-only memory (CD-ROM) that includes program code, and can run on the acoustic system. However, the program product in this specification is not limited thereto. In this specification, a readable storage medium can be any tangible medium that includes or stores a program, and the program can be used by or in combination with an instruction execution system. The program product can be any combination of one or more readable media. The readable medium can be a readable signal medium or a readable storage medium. The readable storage medium can be, for example, an electrical system, apparatus, or device, a magnetic system, apparatus, or device, an optical system, apparatus, or device, an electromagnetic system, apparatus, or device, an infrared system, apparatus, or device, or a semiconductor system, apparatus, or device, or any combination thereof. More specific examples of the readable storage medium include: an electrical connection including one or more conducting wires, a portable disk, a hard disk, a random access memory (RAM), a read-only memory (ROM), an erasable programmable read-only memory (EPROM) or a flash memory, an optical fiber, a portable compact disc read-only memory (CD-ROM), an optical storage component, a magnetic storage component, or any proper combination thereof. The computer-readable storage medium can include a data signal propagated in a baseband or as part of a carrier, and carries readable program code. The propagated data signal can be in a plurality of forms, and includes but is not limited to an electromagnetic signal, an optical signal, or any proper combination thereof. The readable storage medium can further be any readable medium other than the readable storage medium, and the readable medium can be used to send, propagate, or transmit a program used by or in combination with an instruction execution system, apparatus, or component. The program code included in the readable storage medium can be transmitted in any proper medium, including but not limited to a wireless medium, a wired medium, an optical cable, a radio frequency (RF) medium, or any proper combination thereof. Program code for performing an operation of this specification can be written in any combination of one or more program design languages. The program design language includes an object-oriented program design language, for example, Java or C++, and further includes a conventional procedural program design language, for example, “C” language, or a similar program design language. The program code can be completely executed on the acoustic system, partially executed on the acoustic system, executed as an independent software package, partially executed on the acoustic system and partially executed on a remote computing device, or completely executed on a remote computing device.

Specific embodiments of this specification are described above. Other embodiments fall within the scope of the appended claims. In some cases, the actions or steps described in the claims can be performed in an order different from that in the embodiments, and the desired results can still be achieved. In addition, the process depicted in the accompanying drawings does not necessarily need a particular order or consecutive order to achieve the desired results. In some implementations, multitasking and parallel processing are possible or may be advantageous.

In conclusion, after reading the detailed disclosure, a person skilled in the art can understand that the detailed disclosure can be presented only in an example manner, and can impose no limitation. Although it is not explicitly stated here, a person skilled in the art can understand that the requirements of this specification include various proper changes, improvements, and modifications to the embodiments. These changes, improvements, and modifications are intended to be presented in this specification, and fall within the spirit and scope of the example embodiments of this specification.

In addition, specific terms in this specification are used to describe the embodiments of this specification. For example, “one embodiment”, “embodiments”, and/or “some embodiments” mean that a structure or feature can be included in at least one embodiment of this specification in connection with the specific features described in the embodiments. Therefore, it can be emphasized and it should be understood that references to two or more of “embodiments” or “one embodiment” or “alternative embodiments” in all parts of this specification do not necessarily mean the same embodiments. In addition, specific features, structures, or features can be appropriately combined in one or more embodiments of this specification.

It should be understood that, in the above-mentioned descriptions of the embodiments of this specification, to help understand a feature, for a purpose of simplifying this specification, various features are combined in a single embodiment, accompanying drawings, or descriptions thereof. However, this does not mean that a combination of these features is necessary. A person skilled in the art can completely label some devices as separate embodiments for understanding when reading this specification. That is, the embodiments in this specification can also be understood as an integration of a plurality of secondary embodiments. Content of each secondary embodiment is also true when the content is less than all features of one of the above-mentioned disclosed embodiments.

Each patent, patent application, publication of a patent application and other materials, for example, articles, books, instructions, publications, documents, or articles cited in this specification may be incorporated here by reference and used for all purposes now or later associated with this document other than any historical prosecution document that may be inconsistent with or conflicting with this document or any identical historical prosecution document that may have a limiting effect on the widest scope of the claims. In addition, if there is any inconsistency or conflict in the descriptions, definitions, and/or use of terms associated with any included material and terms, descriptions, definitions, and/or use in this document, the term in this document shall prevail.

Finally, it should be understood that the implementations disclosed in this specification describe the principles of the implementations of this specification. Other modified embodiments also fall within the scope of this specification. Therefore, the embodiments disclosed in this specification are merely examples rather than limitations. A person skilled in the art can use an alternative configuration according to the embodiments in this specification to implement the application in this specification. Therefore, the embodiments of this specification are not limited to the embodiments accurately described in this application.

1. A meta learning method of a deep learning model, wherein the method is applied to a cluster comprising N processing nodes, N is an integer greater than 1, and the method comprises:
obtaining a training dataset, wherein the training dataset comprises training samples corresponding to a plurality of tasks; and
performing a plurality of times of iterative training on the deep learning model based on the training dataset in parallel by using the N processing nodes, to obtain a parameter of the deep learning model, wherein in each time of iterative training, each of the N processing nodes learns some parameters of the deep learning model by using some training samples in the training dataset, and the some training samples correspond to a same task in the plurality of tasks.

2. The method according to claim 1, wherein the parameter of the deep learning model comprises an embedding layer parameter and a dense layer parameter; and
each processing node learns some parameters in the embedding layer parameter and all parameters in the dense layer parameter by using the some training samples.

3. The method according to claim 2, wherein the training dataset comprises a plurality of data batches, and a process of each time of iterative training comprises: performing the following operations by using the i^{th} processing node:
determining a target data batch, and dividing the target data batch into a support set and a query set, wherein the target data batch comprises the some training samples, and the target data batch is one of the plurality of data batches;
performing an inner loop training process, wherein the inner loop training process comprises: determining a first embedding layer parameter, determining an inner-loop loss function based on the support set, the first embedding layer parameter, and a current dense layer parameter, and updating the first embedding layer parameter and the current dense layer parameter by optimizing the inner-loop loss function, wherein the current dense layer parameter is updated to an intermediate dense layer parameter; and
performing an outer loop training process, wherein the outer loop training process comprises: determining a second embedding layer parameter, determining an outer-loop loss function based on the query set, the second embedding layer parameter, and the intermediate dense layer parameter, and updating the second embedding layer parameter and the intermediate dense layer parameter by optimizing the outer-loop loss function, wherein
a value of i is a positive integer less than or equal to N, and the first embedding layer parameter and the second embedding layer parameter each correspond to at least some parameters in the embedding layer parameter.

4. The method according to claim 3, wherein before performing an inner loop training process, the method further comprises: interacting with another processing node in the cluster, to obtain a current embedding layer parameter corresponding to the support set, and obtain a current embedding layer parameter corresponding to the query set;
determining a first embedding layer parameter comprises: determining that the current embedding layer parameter corresponding to the support set is the first embedding layer parameter, wherein the first embedding layer parameter is updated to a third embedding layer parameter after the inner loop training process; and
determining a second embedding layer parameter comprises: determining the second embedding layer parameter based on the current embedding layer parameter corresponding to the query set or the third embedding layer parameter.

5. The method according to claim 4, wherein determining the second embedding layer parameter based on the current embedding layer parameter corresponding to the query set or the third embedding layer parameter comprises:
when the query set and the support set have an overlapping element, for an embedding layer parameter corresponding to the overlapping element in a training sample of the query set, determining that the third embedding layer parameter is the second embedding layer parameter; and for an embedding layer parameter corresponding to an element other than the overlapping element in the training sample of the query set, determining that the current embedding layer parameter corresponding to the query set is the second embedding layer parameter; or
when the query set and the support set have no overlapping element, determining that the current embedding layer parameter corresponding to the query set is the second embedding layer parameter.

6. The method according to claim 3, wherein determining an inner-loop loss function based on the support set, the first embedding layer parameter, and a current dense layer parameter comprises:
performing forward computation based on the support set, the first embedding layer parameter, and the current dense layer parameter, to determine the inner-loop loss function; and
updating the first embedding layer parameter and the current dense layer parameter by optimizing the inner-loop loss function comprises:
performing local gradient backward propagation on the inner-loop loss function, to update the first embedding layer parameter and the current dense layer parameter.

7. The method according to claim 3, wherein updating the second embedding layer parameter by optimizing the outer-loop loss function comprises:
determining a gradient of the outer-loop loss function with respect to the embedding layer parameter, to obtain a sub-embedding layer gradient corresponding to the i^{th} processing node;
interacting with another processing node in the cluster, to obtain a sub-embedding layer gradient corresponding to the another processing node in the cluster;
performing aggregation computation on sub-embedding layer gradients corresponding to the N processing nodes, to obtain a target embedding layer gradient; and
updating the second embedding layer parameter based on the target embedding layer gradient.

8. The method according to claim 7, wherein the processing node is a graphics processing unit (GPU) node; and
interacting with another processing node in the cluster, to obtain a sub-embedding layer gradient corresponding to the another processing node in the cluster comprises:
interacting with the another processing node in the cluster by using a first collective communication primitive AlltoAll, to obtain the sub-embedding layer gradient corresponding to the another processing node in the cluster.

9. The method according to claim 3, wherein updating the intermediate dense layer parameter by optimizing the outer-loop loss function comprises:
determining a gradient of the outer-loop loss function with respect to the dense layer parameter, to obtain a sub-dense layer gradient corresponding to the i^{th} processing node;
interacting with another processing node in the cluster, to obtain a sub-dense layer gradient corresponding to the another processing node in the cluster;
performing aggregation computation on sub-dense layer gradients corresponding to the N processing nodes, to obtain a target dense layer gradient; and
updating the intermediate dense layer parameter based on the target dense layer gradient.

10. The method according to claim 9, wherein the processing node is a graphics processing unit (GPU) node; and
interacting with another processing node in the cluster, to obtain a sub-dense layer gradient corresponding to the another processing node in the cluster comprises:
interacting with the another processing node in the cluster by using a second collective communication primitive AllReduce, to obtain the sub-dense layer gradient corresponding to the another processing node in the cluster.

11. The method according to claim 2, wherein before performing a plurality of times of iterative training on the deep learning model based on the training dataset in parallel by using the N processing nodes, the method further comprises:
dividing the embedding layer parameter, to obtain N subsets; and
storing a parameter in the i^{th} subset and the dense layer parameter in the i^{th} processing node, wherein a value of i is a positive integer less than or equal to N.

12. The method according to claim 1, wherein the training dataset comprises a plurality of data batches, and obtaining a training dataset comprises:
determining training samples respectively corresponding to P tasks, wherein each training sample comprises a task identifier of a task to which the training sample belongs, and P is an integer greater than 1; and
splitting the training samples respectively corresponding to the P tasks into Q data batches based on a predetermined batch size, to obtain the training dataset, wherein task identifiers of training samples belonging to a same data batch are consistent, and Q is an integer greater than P.

13. The method according to claim 1, wherein the processing node is a graphics processing unit (GPU) node, the N processing nodes are deployed on a plurality of physical devices, and in a process of the plurality of times of iterative training, different processing nodes within a same physical device communicate through a high-speed connection channel NVLink, and different physical devices communicate through remote direct memory access (RDMA).

14. The method according to claim 1, wherein the deep learning model is a deep learning recommendation model (DLRM).

15. (canceled)

16. A computing device comprising a memory and a processor, wherein the memory stores executable instructions that, in response to execution by the processor, cause the computing device to implement a meta learning method of a deep learning model, wherein the method is applied to a cluster comprising N processing nodes, N is an integer greater than 1, and the method comprises:
obtaining a training dataset, wherein the training dataset comprises training samples corresponding to a plurality of tasks; and
performing a plurality of times of iterative training on the deep learning model based on the training dataset in parallel by using the N processing nodes, to obtain a parameter of the deep learning model, wherein in each time of iterative training, each of the N processing nodes learns some parameters of the deep learning model by using some training samples in the training dataset, and the some training samples correspond to a same task in the plurality of tasks.

17. The computing device according to claim 16, wherein the parameter of the deep learning model comprises an embedding layer parameter and a dense layer parameter; and
each processing node learns some parameters in the embedding layer parameter and all parameters in the dense layer parameter by using the some training samples.

18. The computing device according to claim 17, wherein the training dataset comprises a plurality of data batches, and a process of each time of iterative training comprises: performing the following operations by using the i^{th} processing node:
determining a target data batch, and dividing the target data batch into a support set and a query set, wherein the target data batch comprises the some training samples, and the target data batch is one of the plurality of data batches;
performing an inner loop training process, wherein the inner loop training process comprises: determining a first embedding layer parameter, determining an inner-loop loss function based on the support set, the first embedding layer parameter, and a current dense layer parameter, and updating the first embedding layer parameter and the current dense layer parameter by optimizing the inner-loop loss function, wherein the current dense layer parameter is updated to an intermediate dense layer parameter; and
performing an outer loop training process, wherein the outer loop training process comprises: determining a second embedding layer parameter, determining an outer-loop loss function based on the query set, the second embedding layer parameter, and the intermediate dense layer parameter, and updating the second embedding layer parameter and the intermediate dense layer parameter by optimizing the outer-loop loss function, wherein
a value of i is a positive integer less than or equal to N, and the first embedding layer parameter and the second embedding layer parameter each correspond to at least some parameters in the embedding layer parameter.

19. The computing device according to claim 18, wherein before performing an inner loop training process, the method further comprises: interacting with another processing node in the cluster, to obtain a current embedding layer parameter corresponding to the support set, and obtain a current embedding layer parameter corresponding to the query set;
determining a first embedding layer parameter comprises: determining that the current embedding layer parameter corresponding to the support set is the first embedding layer parameter, wherein the first embedding layer parameter is updated to a third embedding layer parameter after the inner loop training process; and
determining a second embedding layer parameter comprises: determining the second embedding layer parameter based on the current embedding layer parameter corresponding to the query set or the third embedding layer parameter.

20. The computing device according to claim 19, wherein determining the second embedding layer parameter based on the current embedding layer parameter corresponding to the query set or the third embedding layer parameter comprises:
when the query set and the support set have an overlapping element, for an embedding layer parameter corresponding to the overlapping element in a training sample of the query set, determining that the third embedding layer parameter is the second embedding layer parameter; and for an embedding layer parameter corresponding to an element other than the overlapping element in the training sample of the query set, determining that the current embedding layer parameter corresponding to the query set is the second embedding layer parameter; or
when the query set and the support set have no overlapping element, determining that the current embedding layer parameter corresponding to the query set is the second embedding layer parameter.

21. A non-transitory computer-readable storage medium comprising instructions stored therein that, when executed by a processor of a computing device, cause the computing device to implement a meta learning method of a deep learning model, wherein the method is applied to a cluster comprising N processing nodes, N is an integer greater than 1, and the method comprises:
obtaining a training dataset, wherein the training dataset comprises training samples corresponding to a plurality of tasks; and
performing a plurality of times of iterative training on the deep learning model based on the training dataset in parallel by using the N processing nodes, to obtain a parameter of the deep learning model, wherein in each time of iterative training, each of the N processing nodes learns some parameters of the deep learning model by using some training samples in the training dataset, and the some training samples correspond to a same task in the plurality of tasks.
